(19) United States
(12) Patent Application Publication
(10) Pub. No.: US 2015/0293887 A1
(43) Pub. Date: Oct. 15, 2015

(54) VISUALIZATION OF JOB REQUISITION

(71) Applicants: RAGHUNANDAN H, TUMKUR (IN); Anand John GOKULCHANDRAN, Chennai (IN); Tanvi JOSHI, Delhi (IN)

(72) Inventors: RAGHUNANDAN H, TUMKUR (IN); Anand John GOKULCHANDRAN, Chennai (IN); Tanvi JOSHI, Delhi (IN)

(21) Appl. No.: 14/252,794

(22) Filed: Apr. 15, 2014

(51) Int. Cl. G06F 17/21; G06F 17/24

(52) U.S. Cl. CPC G06F 17/212; G06F 17/248

(57) ABSTRACT

Various embodiments of systems and methods for dynamically generating a graphical representation of a job description are described herein. The method involves receiving a request to invoke job description data for a particular job requisition. The job description data is composed of strings of characters such as alphabets, numerals, and punctuation marks. Further, the method involves receiving a request to publish the job description data to an online media. In response to receiving the request to publish, it is automatically determined whether the online media supports image sharing features or not. If it is determined that the online media supports image sharing features, the job description data is dynamically converted into one or more graphical elements and a visual job requisition composed of the one or more graphical elements is generated. The generated visual job requisition is published to the online media.

### FIELD

This application relates generally to Recruiting Management Systems and more specifically to a technology for dynamically generating a graphical representation of a job description.

### BACKGROUND

Over the past few years, the recruitment industry has faced a break through due to the advent of social media recruiting. Taking advantage of this media trend, companies are increasingly seeking out new and improved solutions to the recruiting cycle. One aspect of the recruiting cycle involves reaching out to potential applicants for a job. Typically, companies run hiring campaigns on various online media platforms such as career websites, internet job portals, and social networking media. However, one of the shortcomings in this conventional approach is that the Job Requisition information is conveyed in text-only format. The key barrier to the success of this approach is employee engagement. The need for a candidate to engage himself/herself in closely reading through the long and wordy description of the job requisition such as title, roles and responsibilities, required skills, required qualification, company information, etc., discourages the candidate from fully understanding the job requisition not to mention the limited attention span of an average person. Moreover, with the increasing popularity of photo sharing social networking sites, the textual content of the job requisition does not allow companies to take advantage of such media platforms.

### SUMMARY

Various embodiments of systems and methods for dynamically generating a graphical representation of a job description are described herein. In an aspect, the method involves receiving a request to invoke job description data for a particular job requisition. The job description data is composed of strings of characters such as alphabets, numerals, and punctuation marks. Further, the method involves receiving a request to publish the job description data to an online media. In an aspect, in response to receiving the request to publish, it is automatically determined whether the online media supports image sharing features or not. If it is determined that the online media supports image sharing features, the job description data is dynamically converted into one or more graphical elements and a visual job requisition composed of the one or more graphical elements is generated. In another aspect, the generated visual job requisition is published to the online media. On the other hand, if it is determined that the online media does not support image sharing features, the job description data is published to the online media.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating elements of an exemplary system consistent with implementations of the current subject matter, according to one embodiment.

FIG. 2 is a flow diagram of a method for dynamically generating a graphical representation of a job description, according to one embodiment.

FIG. 3 illustrates a job requisition dashboard, in accordance with an embodiment.

FIG. 4 illustrates a job posting board, in accordance with an embodiment.

FIG. 5 illustrates a job requisition dashboard, in accordance with another embodiment.

FIG. 6 illustrates a graphical representation of the job description, in accordance with an embodiment.

FIG. 7 illustrates a graphical representation of the job description, in accordance with another embodiment.

FIG. 8 is a block diagram of an exemplary computer system according to one embodiment.

### DETAILED DESCRIPTION

### Overview

Embodiments of techniques for dynamically generating a graphical representation of a job description are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Social networking communities, i.e., social structures hosted on social networking systems are made up of individuals (“members”) and a complex set of dyadic ties between these individuals. Online social networking systems provide a web-based services, platform, application software, or site for facilitating the building of social relations (“connections”) among the members who may for example, share interests, activities, backgrounds, or real-life connections. Some of the web-based services include providing a representation of each member (often a profile), his/her social links, and means for members to interact over the internet, such as e-mail, instant messages, media streaming, etc. Examples of online social networking systems include Whatsapp, Instagram, LinkedIn, Twitter, Facebook, MySpace, Google+, and EsqChat.com, where communities of individuals having virtual identities are enabled to connect and interact with other individuals.

In addition to serving as a platform for members to meet and interact with each other, the online social networking systems serve as marketing platforms allowing individuals and companies to create content that encourages members to share it with their connections. By reposting the content, members trigger an electronic word of mouth (eWoM) via the internet (e.g., web sites, social networks, instant messages, news feeds) about an event, product, service, brand, or company. When the underlying message spreads from user to user it presumably resonates because it appears to come from a trusted source. Employers and recruiters increasingly find value in recruiting candidates through the use of social platforms as promotional or advertising channels, or talent databases. Typically, a description of the job requisition referred to as a ‘job opening’ is published on the social platforms seeking applications or walk-ins for screening.

A counterpart of the social networking systems, namely “Image sharing social media” has become increasingly popular in recent years. An image sharing site or app (application software) is one which provides the means for a user to upload their digital images (any file in common image format such as JPEG, GIF, or PNG) for public or private access and display. Consistent with implementations of the current subject matter, the social recruiting process is further enhanced by sharing the job description in a visual form in image sharing social media.

### System Overview

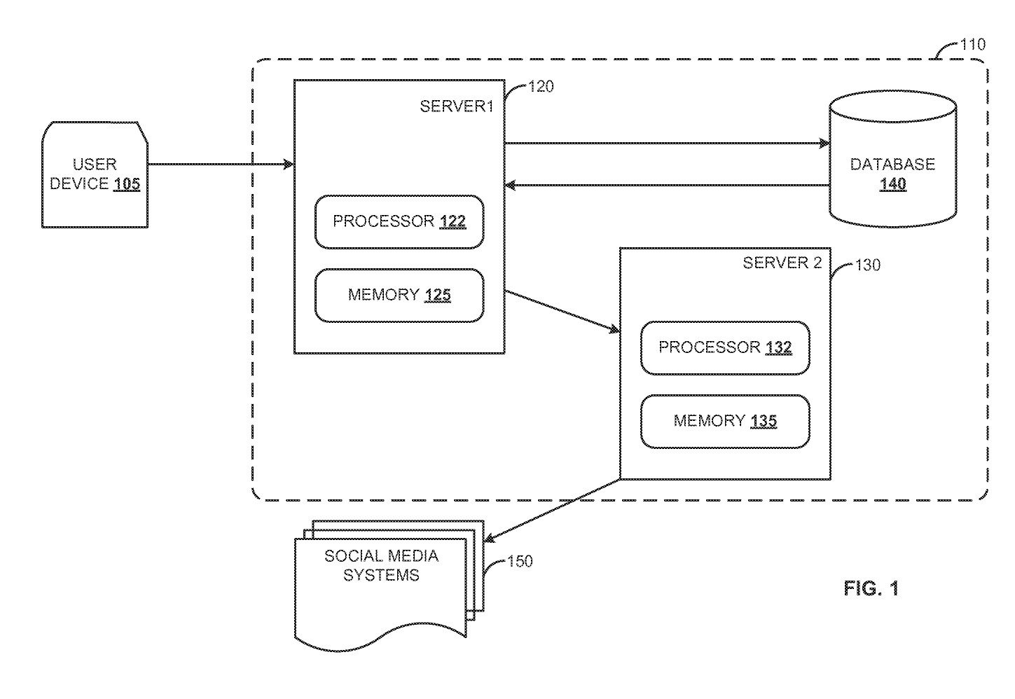

FIG. 1 is a high level block diagram illustrating a system environment, in accordance with one embodiment. The system environment comprises a user device 105, a recruiting management system 110, and one or more social media systems 150. In some embodiments, the recruiting management system 110 is implemented as a single server, while in other embodiments it is implemented as a distributed system of multiple servers. For ease of explanation, the recruiting management system 110 is described below as being implemented on a dual server system. The embodiment shown in FIG. 1 includes first server 120, a second server 130, and a database 140. The first server 120 includes a processor 122 and a memory 125 having instructions for generating a barcode of the job description data and instructions for converting the job description data into graphical elements. The second server 130 includes a processor 132 and a memory 135 storing instructions for generating a snapshot of the visual job requisition and publishing the visual job requisition to the social media systems 150. The recruiting management system 110 is communicatively coupled to a user device 105 and the social media systems 150.

A user interacts with the recruiting management system 110 and the social media systems 150 via the user device 105, which may be any suitable device that is capable of connecting to the recruiting management system 110 and the social media systems 150. Examples of the user device 105 include a computer, a Laptop, a Smartphone, a Personal Digital Assistant, a Notepad, a Notebook, and a Tablet computer. The user device 105 may be accessed by a developer or a recruitment personnel having sufficient authority.

In an aspect, the recruitment management system 110 is operated by the recruiting team of a company or a third party recruiter, hereinafter referred to as a ‘user.’ In an embodiment, the first server 120 receives a selection of a job title or any such identifying information for a job requisition via a user interface of the user device 105. The first server then accesses the database 140 to extract the job description data associated with the selected job title. Using the job description data returned from the database 140, the processor generates a barcode such as a Quick Response (QR) code® for the job description data. A barcode is a machine-readable optical label that contains information about an item, service, or posting on which it is attached. A QR code® uses four standardized encoding modes (numeric, alphanumeric, byte/binary, and kanji) to efficiently store data. Consistent with the current subject matter, the processor 122 converts the job description data into a barcode. In an aspect, the barcode is embedded with a hyperlink/Uniform Resource Identifier (URI/URL) via which the user may navigate to a web page or any such information source using a portable communication device. For example, when the user scans the bar code using his/her mobile phone, the embedded URL is parsed and displayed on the display interface of the mobile device. The user may then access the URL to navigate to a job posting on a web page or portal or a career site. Further, the processor 122 generates one or more graphical elements to visually represent the textual content of the job description data. In an aspect, the visual elements are generated using HyperText Markup Language (HTML), JavaScript, and Cascading Style Sheets (CSS). The first application server 120 sends the visual job requisition to the second application server 130 which generates a snapshot of the visual job requisition and renders a preview of the visual job requisition upon request. Further, the second application server 130 publishes the visual job requisition on the social media system 150.

### Process Overview

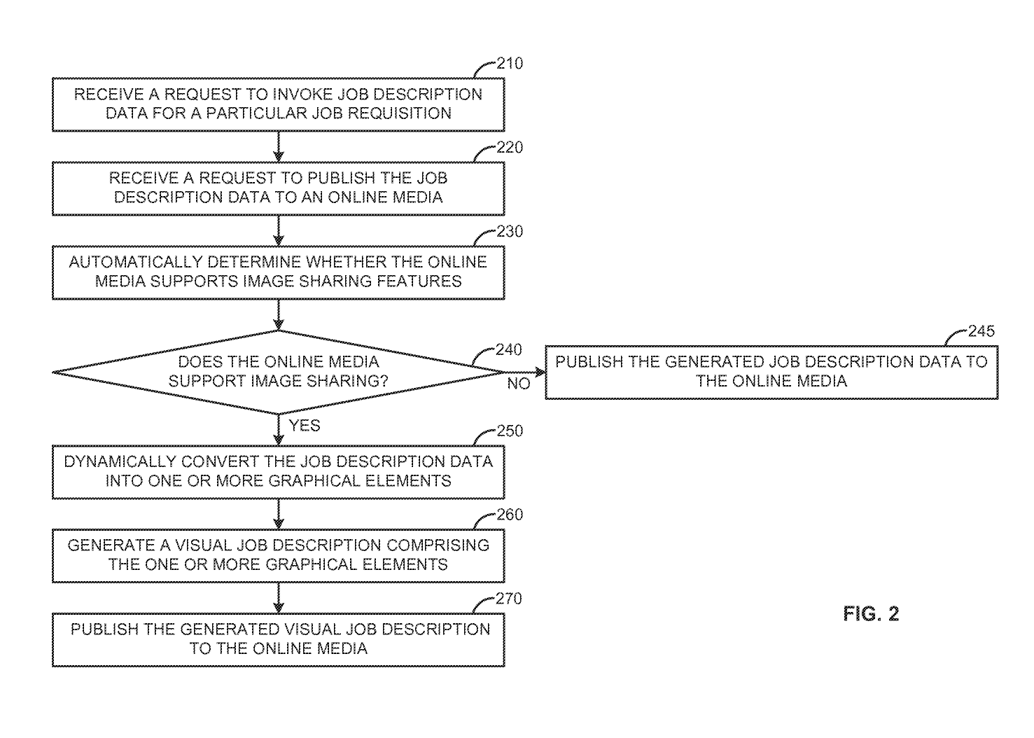

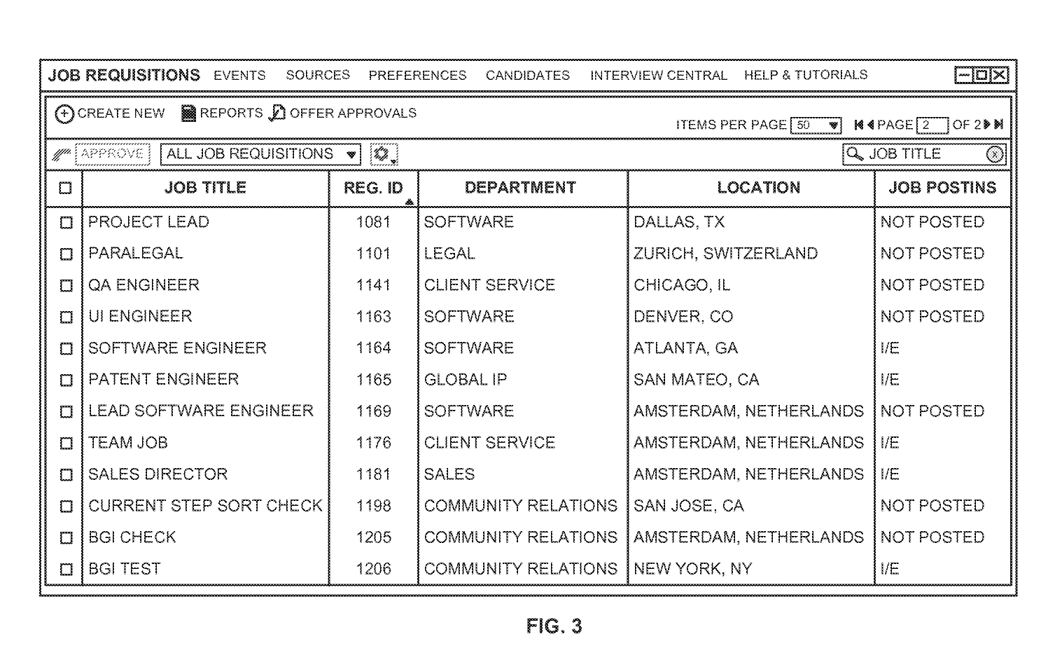

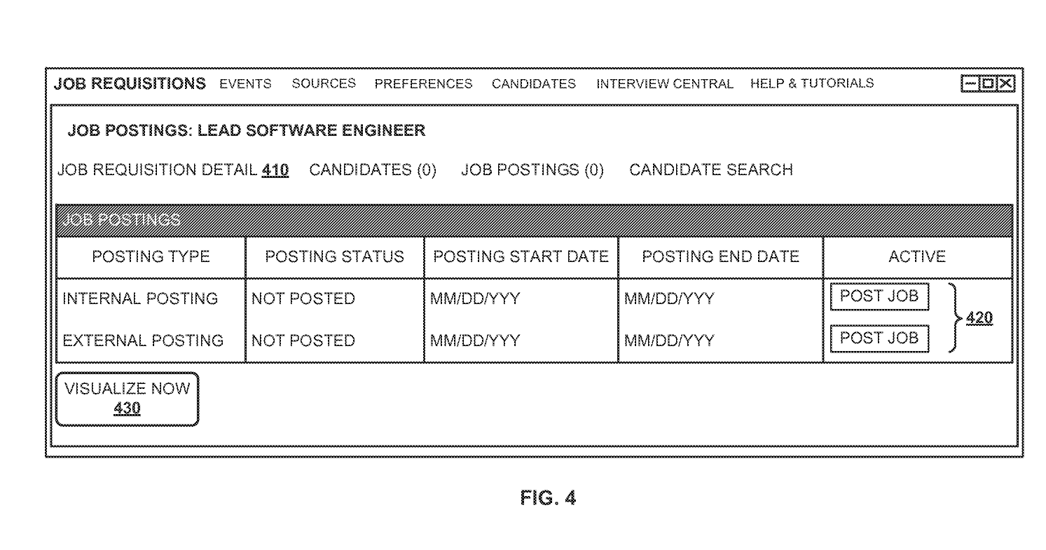

FIG. 2 illustrates a flow diagram of a method 200 for dynamically generating a graphical representation of a job description. Portions of process 200, as shown in FIG. 2, are performed at a system (e.g., recruiting management system 110) having one or more processors and non-transitory memory, which stores one or more instructions to be executed by the one or more processors of the system. In an aspect, a developer or recruiting personnel may create a new job requisition by accessing a dashboard of a visualization tool hosted by the recruiting management system. The dash board may provide a standard template having various fields classified as Job Title, Duties and Responsibilities, Experience, Education, About Company, etc., into which a user can enter descriptive data. The descriptive data is primarily in textual form and may include numeric digits and punctuation marks. The received job description data may be persisted in a repository and can be accessed for editing or publishing at a later point in time. The method 200 involves receiving a request to invoke job description data for a particular job requisition from the repository, at process block 210. In an aspect, a user may access a list of job requisitions using the dashboard, as shown in FIG. 3. As shown in FIG. 3, the job requisitions may be identified by a ‘Job Title’ and ‘Req. ID’ and provided with additional information such as ‘Hiring Manager,’ ‘Recruiter,’ ‘Department,’ ‘Location,’ and ‘Job Posting.’ A user may select a particular job requisition for invoking the corresponding job description data. Alternatively, the user may specify the title of a job, e.g., “QA Engineer,” in a search field of the dashboard. In an embodiment, in response to receiving the selection of a particular job requisition, the corresponding job description data is invoked from the repository and available for the user's viewing or posting. In an aspect, the visualization tool may provide an interface as shown in FIG. 4 having options for the viewer to view (410) the details of the job posting, post (420) the job posting to media platforms, or visualize (430) the job description data for the job requisition.

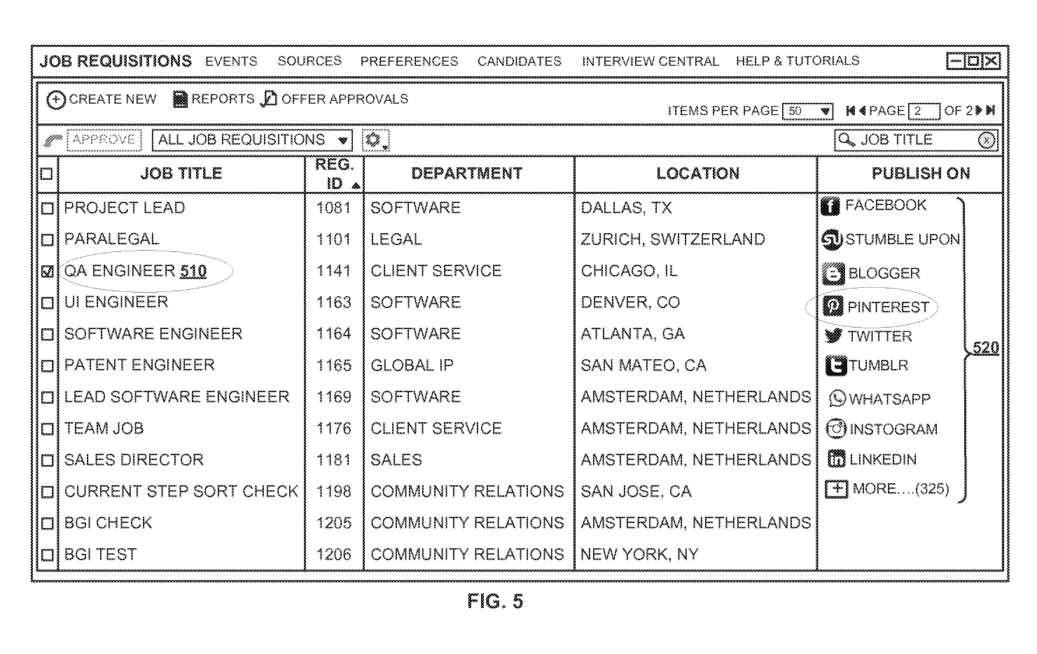

Referring back to FIG. 2, in an alternate embodiment, subsequent to receiving a selection of a particular job requisition, e.g., ‘QA Engineer,’ a request to publish the selected job requisition to an online media platform may be received, at process block 220. As shown in FIG. 5, a user may provide a request to publish a job requisition by simply selecting a particular job requisition 510 and selecting one of several icons 520 representing the online social media. In response to receiving the request to publish the job requisition, the visualization tool automatically determines whether the selected online media supports image sharing features or not, at process block 230.

At process block 240, if it is determined that the selected online media supports image sharing features, the job description data is dynamically converted into one or more graphical elements and a visual job requisition composed of the one or more graphical elements is generated at process blocks 250 and 260. In an embodiment, the job description data is converted into graphical elements by mapping the descriptive data in each field of the template (used for creating the job requisition) to pre-defined graphical elements (e.g., such as histograms, plots, graphs, and charts). The generated visual job requisition is then automatically published to the selected online media at process block 270. In an aspect, a preview of the generated visual job requisition may be provided for the user and the visual job requisition may be posted to the image sharing online media upon receiving a request from the user. On the other hand, if it is determined that the online media does not support image sharing features, at process block 240, the job description data is published to the selected online media in its original form at process block 245.

### Visualization of Job Requisition

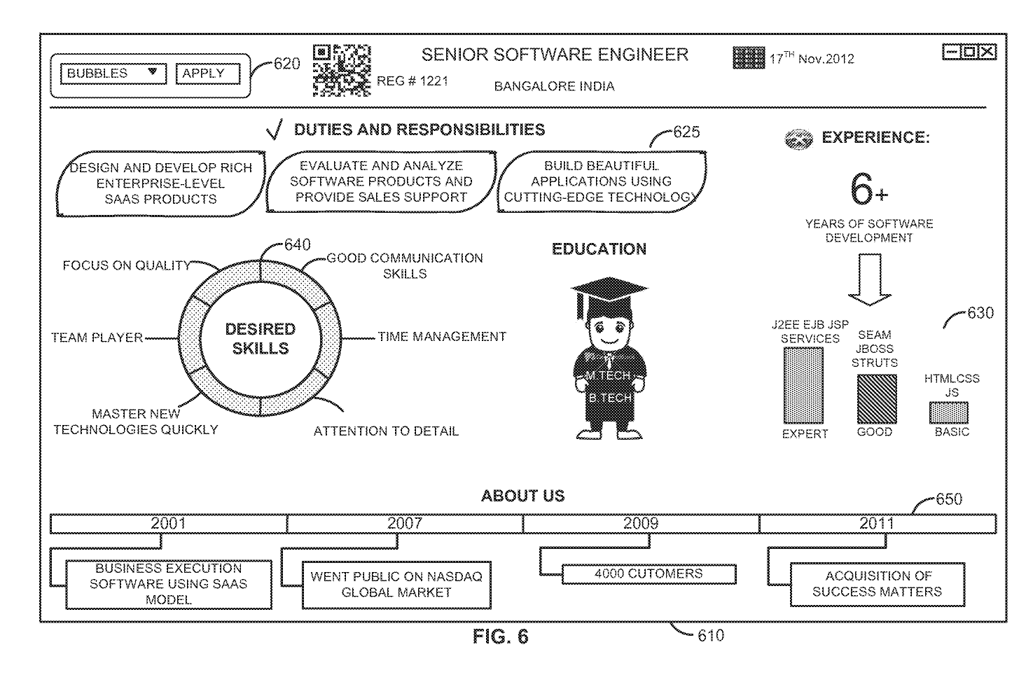

FIG. 6 illustrates a graphical representation 610 of the job description, in accordance with an embodiment. As shown in the example in FIG. 6, the descriptive data for ‘Duties and Responsibilities’ may be configured to be represented by graphical elements 625 in the shape of Tiles. Further, the descriptive data for ‘Experience’ may be represented by a bar graph 630 and the descriptive data for ‘Desired Skills’ by a pie chart 640. Further, the descriptive data about the company may be graphically represented by a time line chart 650. Further, in an aspect, dynamically converting the job description data into graphical elements involves converting the descriptive data into a barcode such as a QR code® and including the barcode in the visual job requisition.

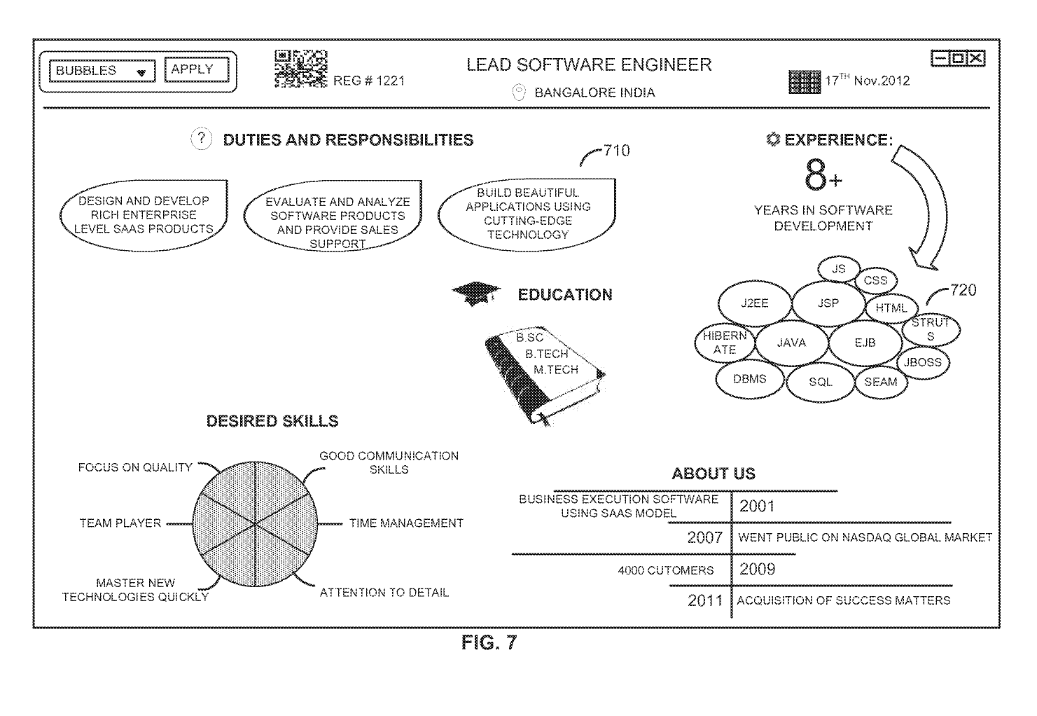

In an aspect, the layout of the visual job description may be created according to a template that may be selected by the user or assigned by default. The visualization tool offers the flexibility of dynamically changing the layout of the visual job description from one form to another in response to receiving a request for changing the layout from the current form. For example, as shown in FIG. 6, a user may select any template from a drop down menu 620 and select the “apply” option. As shown in FIG. 7, the layout 710 is dynamically changed conforming to the new template.

In an embodiment, the graphical elements may be configured to represent the varying degrees of emphasis for certain job description. For example, certain skills may be more preferred over the other and an applicant may be expected to have more working experience in certain areas over others. In such scenarios, the graphical elements may be adapted to represent such varying degrees of emphasis by color coding, varying the dimensions of the graphical elements, etc. In the example shown with reference to FIG. 6, the job requisition for ‘Senior Software Engineer’ requires six or more years of experience, however, the job requisition also requires the candidate to have expert working knowledge ‘J2EE EJB JSP Servlet,’ good working knowledge in ‘Seam JBOSS Struts’ and a basic knowledge of ‘HTML CSS JS.’ This can be highlighted in the visual job description by having varying heights of the bar graph 630. Also, as shown in FIG. 7, the varying sizes of the bubbles 720 and intensity of the color of the bubbles can be used to represent the varying degrees of emphasis on certain requirements.

Further, in an aspect, a user may update the descriptive data for the job requisition in the database and the visualization tool automatically updates the visual job requisition with a graphical element corresponding to the changed/added descriptive data. For example, if the existing skills are viewed in a pie chart form in the visual job requisition and a new skill is added to the descriptive data in the database, the visualization tool automatically adds a new slice to the pie chart.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

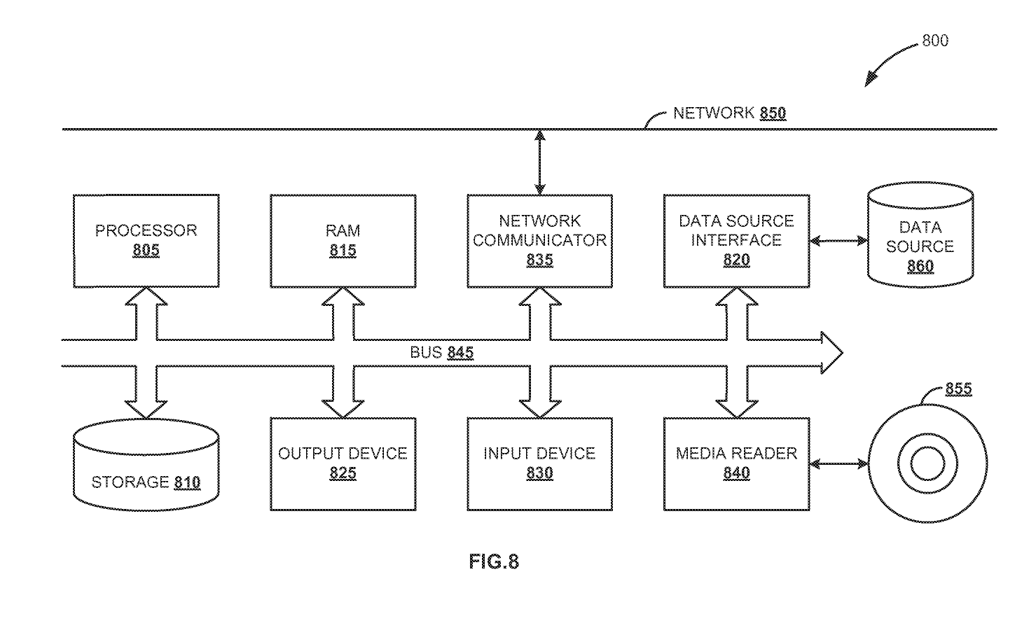

FIG. 8 is a block diagram of an exemplary computer system 800. The computer system 800 includes a processor 805 that executes software instructions or code stored on a computer readable storage medium 855 to perform the above-illustrated methods. The processor 805 can include a plurality of cores. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. According to some embodiments, such as some in-memory computing system embodiments, the RAM 815 can have sufficient storage capacity to store much of the data required for processing in the RAM 815 instead of in the storage 810. In some embodiments, all of the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer-implemented method of dynamically generating a graphical representation of a job description, the method comprising:
receiving a request, via a user interface, to invoke job description data for a particular job requisition, wherein the job description data is composed of strings of characters;
receiving a request, via the user interface, to publish tine job description data to an online media;
in response to receiving the request to publish, automatically determining whether the online media supports image sharing features;
upon determining that the online media supports image sharing features, dynamically converting the job description data into one or more graphical elements;
generating a visual job requisition comprising the one or more graphical elements; and
publishing the generated visual job requisition to the online media.

2. The method of claim 1, wherein upon determining that the online media does not support image sharing features, publishing the job description data to the online media.

3. The method of claim 1 further comprising generating a preview of the visual job requisition and publishing the generated visual job requisition upon receiving a request to publish the previewed visual job requisition.

4. The method of claim 1, wherein automatically determining whether the online media supports image sharing features comprises determining whether the online media is tagged as a media having image sharing capabilities.

5. The method of claim 1, wherein dynamically converting the job description data into the one or more graphical elements further comprises converting the job description data into a barcode and providing the bar code in the generated visual job requisition.

6. The method of claim 1, further comprising receiving a selection of a template for generating the visual job requisition and generating the visual job requisition based on the selected template.

7. The method of claim 1, further comprising receiving an input to modify the job description data and automatically updating the generated visual job requisition with a graphical element corresponding to the received input.

8. A computer program product comprising a non-transitory machine-readable medium storing instructions that, when executed by at least one programmable processor, cause the at least one programmable processor to perform operations comprising:
receiving a request, via a user interface, to invoke job description data for a particular job requisition, wherein the job description data is composed of strings of characters;
receiving a request, via the user interface, to publish description data to an online media;
in response to receiving the request to publish, automatically determining whether the online media supports image sharing features;
upon determining that the online media supports image sharing features, dynamically converting the job description data into one or more graphical elements;
generating a visual job requisition comprising the one or more graphical elements; and
publishing the generated visual job requisition to the online media.

9. The computer program product of claim 8, wherein the operations further comprise: publishing the job description data to the online media upon determining that the online media does not support image sharing features.

10. The computer program product claim 8, wherein the operations further comprise: generating a preview the visual job requisition and publishing the generated visual job requisition upon receiving an request to publish the previewed visual job requisition.

11. The computer program product of claim 8, wherein automatically determining whether the online media supports image sharing features comprises determining whether the online media is tagged as a media having image sharing capabilities.

12. The computer program product of claim 8, wherein dynamically converting the job description data into the one or more graphical elements further comprises converting the job description data into a barcode and providing the bar code in the generated visual job requisition.

13. The computer program product of claim 8, wherein the operations further comprise: receiving an input to modify the job description data and automatically updating the generated visual job requisition with a graphical element corresponding to the received input.

14. The computer program product of claim 8, wherein the operations further comprise: receiving a selection of a template for generating the visual job requisition and generating the visual job requisition based on the selected template.

15. The computer program product of claim 8, wherein the operations further comprise: dynamically changing a layout of the generated visual job requisition in accordance with a layout of a selected template.

16. A system operating in a communication network, comprising:
a computer comprising a memory to store a program code, and a processor to execute the program code to:
receive a request, via a user interface, to invoke job description data for a particular job requisition, wherein the job description data is composed of strings of characters;
receive a request, via the user interface, to publish the job description data to an online media;
in response to receiving the request to publish, automatically determine whether the online media supports image sharing features;
upon determining that the online media supports image sharing features, dynamically convert the job description data into one or more graphical elements;
generate a visual job requisition comprising the one or more graphical elements; and
publish the generated visual job requisition to the online media.

17. The system of claim 16, wherein the strings of characters are composed of a combination of alphabets, numerical digits, and punctuation marks.

18. The system of claim 16, wherein the one or more graphical elements comprise one or more of a histogram, a plot, a graph, and a chart.

19. The system of claim 16, wherein the online media is a software application.

20. The system of claim 16, wherein the online is a web portal.
